(19) United States
(12) Patent Application Publication
(10) Pub. No.: US 2019/0332409 A1
(43) Pub. Date: Oct. 31, 2019

(54) IDENTIFICATION AND STORAGE OF LOGICAL TO PHYSICAL ADDRESS ASSOCIATIONS FOR COMPONENTS IN VIRTUALIZED SYSTEMS

(71) Applicant: Nutanix, Inc., San Jose, CA (US)

(72) Inventors: Adam Fried-Gintis, West Hills, CA (US); Manoj Kumar Agarwal, Palo Alto, CA (US); Rabi Shanker Guha, Santa Clara, CA (US); Thomas Jason Hill, Los Gatos, CA (US)

(73) Assignee: Nutanix, Inc., San Jose, CA (US)

(21) Appl. No.: 15/963,533

(22) Filed: Apr. 26, 2018

(51) Int. Cl. G06F 9/455

(52) U.S. Cl. CPC G06F 9/45558; G06F 2009/45583; G06F 2009/45595

(57) ABSTRACT

A system having a hardware layout wizard, and a method therefore are discussed. The system according to an embodiment includes an administration system including a user interface (UI) and configured to display a visual representation of the plurality of hardware components in accordance with their logical identification; sequentially command each of the plurality of hardware components, in accordance with their respective hardware identification, to provide an output; prompt, via a display device of the administration system UI, a user to provide an identification of a selected one of the plurality of hardware components responsive to the output; and store an association between the plurality of hardware components and a plurality of logical hardware identifiers (IDs) based on the identification.

### TECHNICAL FIELD

Examples described herein relate to virtualized and/or distributed computing systems. Examples of computing systems utilizing a user interface to facilitate identification and storage of logical-to-physical address associations for hardware components are described.

### BACKGROUND

A virtual machine (VM) generally refers to a software-based implementation of a machine in a virtualization environment, in which the hardware resources of a physical computer (e.g., CPU, memory, etc.) are virtualized or transformed into the underlying support for the fully functional virtual machine that can run its own operating system and applications on the underlying physical resources just like a real computer.

Virtualization generally works by inserting a thin layer of software directly on the computer hardware or on a host operating system. This layer of software contains a virtual machine monitor or “hypervisor” that allocates hardware resources dynamically and transparently. Multiple operating systems may run concurrently on a single physical computer and share hardware resources with each other. By encapsulating an entire machine, including CPU, memory, operating system, and network devices, a virtual machine may be completely compatible with most standard operating systems, applications, and device drivers. Most modern implementations allow several operating systems and applications to safely run at the same time on a single computer, with each having access to the resources it needs when it needs them.

One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine may not be utilized to perform useful work. This may be wasteful and inefficient if there are users on other physical machines which are currently waiting for computing resources. Virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

Virtualized and/or other distributed computing systems may utilize a variety of hardware components (e.g., lights, sensors, disks). The hardware components may be provided by a myriad of vendors and may have varying requirements for interfacing with the hardware components (e.g., commands and/or syntax used to control the hardware components).

### BRIEF DESCRIPTION OF THE DRAWINGS

FIG. 1 is a block diagram of a distributed computing system according to examples described herein.

FIG. 2 is a flow diagram of an implementation of executable instructions for identifying components according to examples described herein.

FIG. 3 is a block diagram of a computing node subsystem in the distributed computing system arranged in accordance with examples described herein.

FIG. 4 is a screenshot of a portion of the distributed computing system according to examples described herein.

FIG. 5 is a hard drive alert scheduling technique for the distributed computing system according to examples described herein.

### DETAILED DESCRIPTION

Certain details are set forth herein to provide an understanding of described embodiments of technology. However, other examples may be practiced without various of these particular details. In some instances, well-known virtualized and/or distributed computing system components, circuits, control signals, timing protocols, and/or software operations have not been shown in detail in order to avoid unnecessarily obscuring the described embodiments. Other embodiments may be utilized, and other changes may be made, without departing from the spirit or scope of the subject matter presented here.

Examples described herein may provide systems and methods for qualifying a hardware platform in preparation for installation and/or upgrading of various software components. For example, virtualized systems described herein may include computing nodes which may execute operating systems. The operating systems may include and/or be in communication with a vendor-agnostic hardware interface for controlling various hardware components in the virtualized system. The vendor-agnostic hardware interface may be used to translate vendor-agnostic commands for various hardware components issued by applications in the virtualized system into vendor-specific commands provided to the hardware component. Use of these vendor-agnostic hardware (HW) interface services and/or other interfaces to hardware components, however, may generally utilize knowledge of the hardware components in the system. Developing knowledge of the hardware components may generally be referred to as qualifying the system. Since the operating systems and/or other software described herein may be utilized on a variety of different hardware platforms, qualification of the platform may first occur to provide knowledge of various of the hardware components.

In some examples, different versions of operating systems, application software, and/or vendor-agnostic interfaces may be manually written and/or constructed for different hardware platforms. This manual process, however, may be tedious and/or error prone. Examples described herein describe systems, methods, and user interfaces that may be used to qualify a platform. Methods, systems, and user interfaces described herein may utilize less manual intervention by software developers and may facilitate the execution of tests, etc., which may increase the accuracy of the qualification in some examples.

Accordingly, examples described herein provide for user interfaces, such as guided wizards, in virtualized systems. User interfaces described herein may be used to qualify a platform of a virtualized system. The user interface may be used to identify various hardware components, for example, in response to cues (e.g., prompts on a user interface of an administration system in communication with the computing node) provided to a user. The type, number and alignment of hardware components (e.g., disks) may be identified by using the user interface. The alignment of the disks may correspond to a location (e.g., physical and/or logical location or other identification) of the disks, which may also be provided using the user interface. The identified type, number and alignment of the disks may be used to render an as-is image of a chassis of the computing node. The user interface may be used to identify a hardware component type (e.g., vendor, serial number, model number, etc.) of the disks based on the location provided.

The user interface may provide cues to the user and guide the user through screens used to collect information which helps qualify a system (e.g., understand an association between logical addresses and physical addresses of multiple components). The information collected using the user interface may provide details regarding the arrangement of components including the type, number, alignment, and/or location of disks. The screens used to collect the information regarding the disks may include a plurality of different screens each providing cues for different types of information. For example, a first screen of a user interface may display a prompt requesting the user to enter the chassis form factor, which is generally a multiple of a unit of rack space (e.g., denoted by U). A set of screens may display a prompt requesting the user to draw or otherwise indicate and/or depict available components (e.g., disk slots) and/or component locations. While the prompt requesting the user to depict available component locations (e.g., disk slots) is displayed, one by one, the components may be provided a command causing an observable output. For example, disk light emitting diodes (LEDs) may be blinked. In other examples, other outputs may be generated (e.g., visual and/or audible). The outputs are provided so that the user may observe the output and indicate, using the user interface, which of the available locations corresponds to the particular component. In this manner, a physical (e.g., slot-to-phy) mapping of the disks is generated, which may facilitate workflows such as pointing out the faulty disk in case of disk failures. In some examples, one or more screens of a user interface may be used to detect sensors. For example, sensors on a chassis may be located by requesting the user to click or otherwise indicate a portion of the user interface corresponding to each of the sensors in response to a prompt by the user interface. A final screen for verifying all of the information obtained in the previous steps may be displayed. The user may enter additional information including the model name of each of the components in response to prompts on the final screen. In some examples, the model name of each of the components (e.g., disk drives) may be pre-populated based on a best effort of the user.

Accordingly, user interfaces described herein may facilitate qualification of the platforms for virtualized systems. Using user interfaces described herein may lower the level of expertise and effort used to qualify a platform. The user may be more easily able to install an operating system or other software on a new platform that has not been previously qualified.

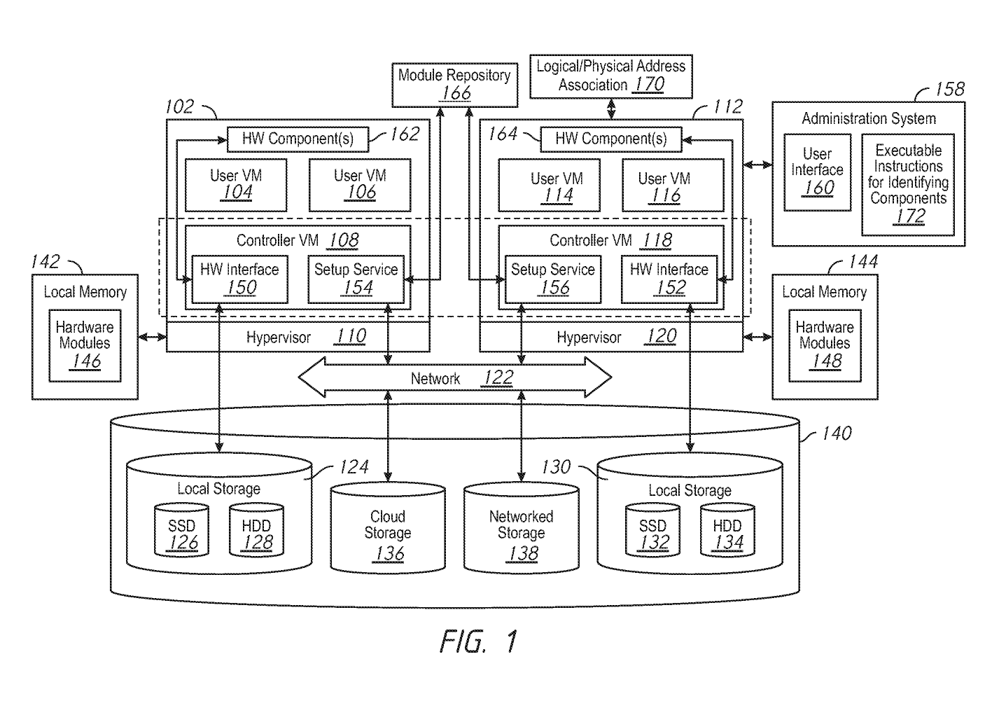

FIG. 1 is a block diagram of a virtualized computing system, arranged in accordance with examples described herein. The virtualized computing system (e.g., distributed computing system) of FIG. 1 generally includes the computing node 102 and the computing node 112 and the storage 140 connected to the network 122. The network 122 may be any type of network capable of routing data transmissions from one network device (e.g., the computing node 102, the computing node 112, and the storage 140) to another. For example, the network 122 may be a local area network (LAN), wide area network (WAN), intranet, Internet, or a combination thereof. The network 122 may be a wired network, a wireless network, or a combination thereof.

The storage 140 may include the local storage 124, the local storage 130, the cloud storage 136, and the networked storage 138. The local storage 124 may include, for example, one or more SSDs 126 and one or more HDDs 128. Similarly, the local storage 130 may include the SSD 132 and the HDD 134. The local storage 124 and the local storage 130 may be directly coupled to, included in, and/or accessible by a respective computing node 102 and/or computing node 112 without communicating via the network 122. Other nodes, however, may access the local storage 124 and/or the local storage 130 using the network 122. The cloud storage 136 may include one or more storage servers that may be stored remotely to the computing node 102 and/or the computing node 112 and accessed via the network 122. The cloud storage 136 may generally include any type of storage device, such as HDDs SSDs, or optical drives. The networked storage 138 may include one or more storage devices coupled to and accessed via the network 122. The networked storage 138 may generally include any type of storage device, such as HDDs SSDs, or optical drives. In various embodiments, the networked storage 138 may be a storage area network (SAN). The computing node 102 is a computing device for hosting VMs in the distributed computing system according to the embodiment. The computing node 102 may be, for example, a server computer, a laptop computer, a desktop computer, a tablet computer, a smart phone, or any other type of computing device. The computing node 102 may include one or more physical computing components (e.g., hardware (HW) components 162 and 164).

Accordingly, computing nodes described herein may include hardware components—such as HW component(s) 162 and HW component(s) 164 shown in FIG. 1. Hardware components may include, but are not limited to, processor(s), sensor(s) (e.g., fan speed sensors, temperature sensors), lights (e.g., one or more LEDs, memory devices, and/or disks). Local storage may in some examples include one or more of the hardware components—such as local storage 124 and/or local storage 130.

The computing node 102 may be configured to execute the hypervisor 110, the controller VM 108, and one or more user VMs, such as user VMs 104, 106. The controller VM 108 may include a HW interface 150 and a setup service 154. The controller VM 118 may include a hardware interface 152 and a setup service 156.

The user VMs including user VM 104 and user VM 106 are VM instances executing on the computing node 102. The user VMs including user VM 104 and user VM 106 may share a virtualized pool of physical computing resources such as physical processors and storage (e.g., storage 140). The user VMs including user VM 104 and user VM 106 may each have their own operating system, such as Windows or Linux. While a certain number of user VMs are shown, generally any number may be implemented. User VMs may generally be provided to execute any number of applications which may be desired by a user.

The hypervisor 110 may be any type of hypervisor. For example, the hypervisor 110 may be ESX, ESX(i), Hyper-V, KVM, or any other type of hypervisor. The hypervisor 110 manages the allocation of physical resources (such as storage 140 and physical processors) to VMs (e.g., user VM 104, user VM 106, and controller VM 118) and performs various VM related operations, such as creating new VMs and cloning existing VMs. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API.

Controller VMs (CVMs) described herein, such as the controller VM 108 and/or the controller VM 118, may provide services for the user VMs in the computing node. As an example of functionality that a controller VM may provide, the controller VM 108 may provide virtualization of the storage 140. Controller VMs may provide management of the distributed computing system according to the embodiment. Examples of controller VMs may execute a variety of software and/or may manage (e.g., serve) the I/O operations for the hypervisor and VMs running on that node. In some examples, a SCSI controller, which may manage SSD and/or HDD devices described herein, may be directly passed to the CVM, e.g., leveraging VM-Direct Path. In the case of Hyper-V, the storage devices may be passed through to the CVM.

The computing node 112 may include user VM 114, user VM 116, a controller VM 118, and a hypervisor 120. The user VM 114, user VM 116, the controller VM 118, and the hypervisor 120 may be implemented similarly to analogous components described above with respect to the computing node 102. For example, the user VM 114 and user VM 116 may be implemented similarly as described above as for the user VM 104 and user VM 106, respectively. The controller VM 118 may be implemented as described above with respect to controller VM 108. The hypervisor 120 may be implemented as described above with respect to the hypervisor 110. The hypervisor 120 may be included in the computing node 112 to access, by using a plurality of user VMs, a plurality of storage devices in a storage pool. In the embodiment of FIG. 1, the hypervisor 120 may be a different type of hypervisor than the hypervisor 110. For example, the hypervisor 120 may be Hyper-V, while the hypervisor 110 may be ESX(i).

Controller VMs, such as the controller VM 108 and the controller VM 118, may each execute a variety of services and may coordinate, for example, through communication over network 122. Namely, the controller VM 108 and the controller VM 118 may communicate with one another via the network 122. By linking the controller VM 108 and the controller VM 118 together via the network 122, a distributed network of computing nodes including computing node 102 and computing node 112, can be created.

Services running on controller VMs may utilize an amount of local memory to support their operations. For example, services running on the controller VM 108 may utilize memory in local memory 142. Services running on the controller VM 118 may utilize local memory 144. The local memory 142 and the local memory 144 may be shared by VMs on computing node 102 and computing node 112, respectively, and the use of the local memory 142 and/or the local memory 144 may be controlled by hypervisor 110 and hypervisor 120, respectively. Moreover, multiple instances of the same service may be running throughout the distributed system—e.g. a same services stack may be operating on each controller VM. For example, an instance of a service may be running on the controller VM 108 and a second instance of the service may be running on the controller VM 118.

Generally, controller VMs described herein, such as the controller VM 108 and the controller VM 118 may be employed to control and manage any type of storage device, including all those shown in the storage 140 of FIG. 1, including the local storage 124 (e.g., SSD 126 and HDD 128), the cloud storage 136, and the networked storage 138. Controller VMs described herein may implement storage controller logic and may virtualize all storage hardware as one global resource pool (e.g., storage 140) that may provide reliability, availability, and performance. IP-based requests are generally used (e.g., by user VMs described herein) to send I/O requests to the controller VMs. For example, the user VM 104 and the user VM 106 may send storage requests the controller VM 108 using an IP request. Controller VMs described herein, such as the controller VM 108, may directly implement storage and I/O optimizations within the direct data access path.

Note that controller VMs are provided as virtual machines utilizing hypervisors described herein—for example, the controller VM 108 is provided behind the hypervisor 110. Since the controller VMs running “above” the hypervisor examples described herein may be implemented within any virtual machine architecture, the controller VMs may be used in conjunction with generally any hypervisor from any virtualization vendor.

Virtual disks (vDisks) may be structured from the storage devices in storage 140, as described herein. A vDisk generally refers to the storage abstraction that may be exposed by a controller VM to be used by a user VM. In some examples, the vDisk may be exposed via iSCSI (“internet small computer system interface”) or NFS (“network file system”) and may be mounted as a virtual disk on the user VM. For example, the controller VM 108 may expose one or more vDisks of the storage 140 and may mount a vDisk on one or more user VMs, such as user VM 104 and/or user VM 106.

During operation, user VMs (e.g., user VM 104 and/or user VM 106) may provide storage input/output (I/O) requests to controller VMs (e.g., the controller VM 108 and/or the hypervisor 110). Accordingly, a user VM may provide an I/O request to a controller VM as an iSCSI and/or NFS request. Internet Small Computer System Interface (iSCSI) generally refers to an IP-based storage networking standard for linking data storage facilities together. By carrying SCSI commands over IP networks, iSCSI can be used to facilitate data transfers over intranets and to manage storage over any suitable type of network or the Internet. The iSCSI protocol allows iSCSI initiators to send SCSI commands to iSCSI targets at remote locations over a network. In some examples, user VMs may send I/O requests to controller VMs in the form of NFS requests. Network File System (NFS) refers to an IP-based file access standard in which NFS clients send file-based requests to NFS servers via a proxy folder (directory) called “mount point”. Generally, then, examples of systems described herein may utilize an IP-based protocol (e.g., iSCSI and/or NFS) to communicate between hypervisors and controller VMs.

During operation, user VMs described herein may provide storage requests using an IP based protocol. The storage requests may designate the IP address for a controller VM from which the user VM desires I/O services. The storage request may be provided from the user VM to a virtual switch within a hypervisor to be routed to the correct destination. For example, the user VM 104 may provide a storage request to hypervisor 110. The storage request may request I/O services from the controller VM 108 and/or the controller VM 118. If the request is intended to be handled by a controller VM in a same service node as the user VM (e.g., the controller VM 108 in the same computing node as user VM 104) then the storage request may be internally routed within computing node 102 to the controller VM 108. In some examples, the storage request may be directed to a controller VM on another computing node. Accordingly, the hypervisor (e.g., hypervisor 110) may provide the storage request to a physical switch to be sent over a network (e.g., network 122) to another computing node running the requested controller VM (e.g., computing node 112 running the controller VM 118).

Accordingly, controller VMs described herein may manage I/O requests between user VMs in a system and a storage pool. Controller VMs may virtualize I/O access to hardware resources within a storage pool according to examples described herein. In this manner, a separate and dedicated controller (e.g., controller VM) may be provided for each and every computing node within a virtualized computing system (e.g., a cluster of computing nodes that run hypervisor virtualization software), since each computing node may include its own controller VM. Each new computing node in the system may include a controller VM to share in the overall workload of the system to handle storage tasks.

Therefore, examples described herein may be advantageously scalable, and may provide advantages over approaches that have a limited number of controllers. Consequently, examples described herein may provide a massively-parallel storage architecture that scales as and when hypervisor computing nodes are added to the system.

Examples of controller VMs (e.g., controller VM 108 and controller VM 118) described herein may provide a HW interface service, such as HW interface service 150 and HW interface 152, respectively. The HW interface services 150 and 152 may be implemented, for example, using software (e.g., executable instructions encoded in one or more computer readable media) to perform the functions of the HW interface services 150 and 152 described herein. The HW interface services 150 and 152 may use information provided in a logical/physical address association 170 to generally translate the generic commands for controlling hardware components into the specific commands for hardware components to be controlled.

For example, the controller VM 108 may receive a request to control hardware. The request to control the hardware may include the generic command intended for a particular hardware component to be controlled. The generic command may be a variety of different types of generic commands. For example, the generic command may be a command to blink a light and/or obtain a sensor reading. The generic command may not be formatted for the particular hardware device to which it is directed. Instead, the generic command may be provided in a format and/or syntax used by the HW interface service to receive generic commands.

The request to control hardware may include an identification of the hardware component to be controlled. The particular hardware component may be identified, for example, by its location (e.g., physical and/or logical location or other identification) in the virtualized system.

The request to control hardware may be provided, for example, from one or more user VMs (e.g., user VM 104 and/or user VM 108). In some examples, the request to control hardware may be provided by another computing system in communication with the HW interface 150 described herein, such as an administration system 158 of FIG. 1. The request to control hardware may, for example, be provided through user interface 160 of FIG. 1.

HW interface services described herein may use the information stored in the module repository 166 to translate a generic command (e.g., a vendor-agnostic command) into a command specific for the intended hardware component. Accordingly, HW interface services described herein may identify information about a particular hardware component, such as a type, model, and/or vendor. In some examples, that information may be provided together with the request to control the particular hardware component. However, in some examples, the particular hardware to be controlled may be identified by its location (e.g., physical and/or logical location) in the virtualized computing system by using the logical/physical address association 170. HW interface services described herein may access data in the virtualized computing system (e.g., in logical/physical address association 170 or storage 140) which associates the location of the particular hardware component with details regarding the particular hardware component (e.g., type, model, and/or vendor).

The HW interface services described herein may transform (e.g., translate) a generic command into a specific command for the particular HW component. For example, a plurality of hardware modules may be accessible to the HW interface service. Referring to FIG. 1, hardware modules 146 may be accessible to HW interface service 150. The hardware modules 146 are shown stored in local memory 142, however the hardware modules 146 may in some examples be stored in local storage 124 and/or elsewhere in the storage 140. The hardware modules 146 may include software code and/or other data that associates hardware functionality (e.g., vendor-specific functionality) with generic commands. In this manner, a HW interface service may access a hardware module associated with the particular hardware component to be controlled. The HW interface service 150 may utilize the hardware modules 146 to translate a generic command into a specific command for the particular hardware component.

The HW interface service 150 may provide the specific command to the particular hardware component. For example, the HW interface service 150 may access one or more hardware module(s) 146 to translate a generic command into a specific command for a particular one of the HW component(s) 162. The HW interface service 150 may provide the specific command to the particular one of the HW component(s) 162. In some examples, the HW interface service 150 may provide the specific command to the controller VM 108 which may in turn provide the specific command to the particular one of the HW component(s) 162. To provide the specific command from the controller VM 108 to the particular one of the HW component(s) 162, the HW interface service 150 may provide the logical address of the particular hardware component to the logical/physical address association 170 to obtain the physical location of the particular hardware component from the logical/physical address association 170. The HW interface service 152 may be implemented as described above with respect to the HW interface service 150.

Examples of systems described herein may include one or more setup services, such as setup service 154 and setup service 156 of FIG. 1. As shown in FIG. 1, setup services (e.g., setup service 154 and setup service 156) described herein may be provided as part of one or more controller VMs (e.g., controller VM 108 and controller VM 118, respectively) in a virtualized system. In some examples, all or portions of setup services may be provided on additional computing systems, such as the administration system 158 of FIG. 1. Setup services described herein may include software code that causes the imaging, provisioning, configuring, and/or other setup of one or more computing nodes. In examples described herein, setup services may support the imaging of one or more computing nodes to include hardware modules appropriate for the computing node. For example, setup service 154 may, during an imaging process of the computing node 102, provide hardware modules 146 in the local memory 142 and/or other storage accessible to the computing node 102.

For example, during an imaging of the node 102, the setup service 154 may identify a type, vendor, version, and/or other identifying information regarding components of the computing node 102, including the operating system executed by the controller VM 108, and/or user VMs 104 and/or 106, the hypervisor 110, and/or the HW component(s) 162. Based on this identifying information, the setup service 154 may identify appropriate hardware modules for installation on the computing node 102. For example, hardware modules may be identified which translate generic commands into specific commands for one or more of the HW component(s) 162 and compatible with the operating system and/or hypervisor running on the computing node 102. The identified hardware modules may be selected from a module repository, such as module repository 166 in FIG. 1. The setup service 156 may be implemented as described above with respect to the setup service. 154.

Examples of systems described herein may accordingly include module repositories. Module repositories, such as the module repository 166 of FIG. 1, may provide storage of multiple hardware modules described herein. The storage may accessible to computing nodes in a virtualized system, such as computing nodes 102 and 112 of FIG. 1. The storage of the module repository 166 may in some examples be located in storage 140, however in other examples, the module repository 166 may be stored in a location other than virtualized storage pool (e.g., storage 140). Setup services described herein may access the module repository and copy selected hardware modules to local storage and/or local memory of computing nodes during an imaging process. In this manner. HW interface services at each computing node may have locally stored hardware modules for the particular hardware components, operating systems, and/or hypervisors present on the computing node. Vendors or other providers may have access to the module repository to create and/or update hardware modules.

Accordingly, examples described herein may include HW interface services and/or setup services which may advantageously make use of knowledge of information about particular hardware components. Examples of administration systems described herein may provide user interfaces for collecting information about the hardware components for use by these or other services.

Examples of systems described herein may include one or more administration systems, such as the administration system 158 of FIG. 1. The administration system may be implemented using, for example, one or more computers, servers, laptops, desktops, tablets, mobile phones, or other computing systems. In some examples, the administration system 158 may be wholly and/or partially implemented using one of the computing nodes of a distributed computing system described herein. However, in some examples (such as shown in FIG. 1), the administration system 158 may be a different computing system from the virtualized system and may be in communication with a controller VM of the virtualized system (e.g., controller VM 108 of FIG. 1) using a wired or wireless connection (e.g., over a network).

The administration system 158 may host one or more user interfaces, e.g., user interface 160. The administration system 158 may be implemented using a computing system (e.g., server) which may be in communication with the nodes 102 and/or 112. The administration system may include one or more processors and computer readable media (e.g., memory) encoded with executable instructions for performing actions described herein. For example, the administration system 158 may include computer readable media encoded with executable instructions for identifying components 172 described herein. The administration system 158 in some examples may be in communication with additional clusters. The administration system 158 may include any number of input and/or output devices which may facilitate implementation of the user interface 160. The user interface 160 may be implemented, for example, using a display of the administration system 158. The administration system 158 may receive input from one or more users (e.g., administrators) by using a touch screen of the display configured to display the user interface 160 or by using one or more input device(s) of the administration system 158, such as, but not limited to, a keyboard, mouse, touchscreen, and/or voice input. The input received from the one or more users may be provided to controller VM 108 in some examples. The input received from the one or more users may be information provided by the user to the administration system 158 using the interface 160 regarding one or more components of the system shown in FIG. 1, such as the HW components 162 and/or HW components 164. The input received from the one or more users may identify one or more components during an automated process for qualifying the new platform for each of the computing nodes.

The user interface 160 may be implemented, for example, using a web service provided by the controller VM 108 or one or more other controller VMs described herein. In some examples, the user interface 160 may be implemented using a web service provided by the controller VM 108 and information from the controller VM 108 (e.g., type from HW interface service 150) may be provided to the controller VM 108 for display in the user interface 160.

The administration system 158 may include executable instructions for identifying components 172. The executable instructions for identifying components 172 may be used to display of a variety of user prompts and/or other guidance to solicit input for qualifying the platform.

During qualification of the system of FIG. 1 (e.g., including computing node 102), the executable instructions for identifying components 172 may, for example, control the user interface 160 to provide cues to a user and guide the user through screens used to collect information which helps complete the picture of an arrangement of the components (e.g., disks). The information provided by the user and collected by using the administration system 158 may be used to store associations between logical and physical addresses of the components, e.g., in a database of logical/physical address associations 170. The user interface 160 used to collect the information regarding the components may include a plurality of different screens each providing cues for different types of information.

The associations between logical and physical addresses of components may be, for example, associations between slot numbers and logical addresses for the components. The associations may be stored in generally any format, including a list, a database, or other data structure. The associations may be stored in electronic memory and/or storage accessible to the computing nodes in a distributed system. For example the logical/physical address associations 170 may be stored in storage 140 in some examples and/or may be stored in local memory 142 and/or local memory 144.

During configuration, the executable instructions for identifying components 172 may control the user interface 160 to display a set of screens to provide prompts requesting the user to draw all available components (e.g., disk slots available). While the prompts requesting the user to draw all available components (e.g., disk slots available) are displayed, the user may draw an available location for each component (e.g., disk slot). Information about the available locations for the components (e.g., disk slots) may also be obtained in some other way (e.g., pre-stored).

After the available locations for the components (e.g., disk slots) are drawn, one by one, outputs (e.g., disk LEDs) may be activated (e.g., blinked). The user may select a corresponding component (e.g., disk slot) when each output (e.g., disk LED) is activated (e.g., blinked). A variety of configurations between the executable instructions for identifying components 172 and the computing nodes (e.g., computing node 102) may be used to activate (e.g., blink) the outputs (e.g., disk LEDs). For example, the executable instructions for identifying components 172 may transmit a signal via the computing node 102 to an output (e.g., disk LED) of a component (e.g., disk drive). Alternatively, the executable instructions for identifying components 172 may transmit a signal to flag the computing node 102 to transmit a signal activating (e.g., enabling) the output (e.g., disk LED) of the disk drive to activate (e.g., blink). A variety of configuration methods may be used by the executable instructions for identifying components 172 to identify outputs (e.g., disk LEDs) including activating (e.g., blinking) a single output (e.g., disk LED) or blinking a plurality of outputs (e.g., disk LEDs). The outputs (e.g., disk LEDs) may be activated (e.g., blinked) so that the user may input information regarding an available location of one of the components (e.g., disk slots). This is a critical step because the slot to physical (i.e., slot-to-phy) mapping of the disks is generated, which helps workflows such as pointing out the faulty disk in case of disk failures. A variety of configuration methods may be used for the user to input the information regarding the available location of the corresponding component (e.g., disk slot) including the user clicking on a portion of the user interface to select a representative image of the corresponding component (e.g., disk slot) or drawing a symbol representing the available location of the corresponding component (e.g., disk slot).

During configuration, the executable instructions for identifying components 172 may control the user interface 160 to display a plurality of screens to detect sensors. In a case where locating sensors on the chassis makes sense, sensors on the chassis may be located by the user clicking on a portion of the user interface 160 corresponding to each of the sensors in response to a prompt by the user interface 160.

During configuration, the executable instructions for identifying components 172 may control the user interface 160 to display prompts for the user to input a type, number and alignment of the components (e.g., data disks) by using the executable instructions for identifying components 172. In addition, the executable instructions for identifying components 172 may control the user interface 160 to display a final screen for verifying all of the information obtained in the previous steps. The executable instructions for identifying components 172 may control the user interface 160 to display the final screen to provide a prompt requesting the user to enter the chassis form factor, which is generally a multiple of a unit of rack space (e.g., denoted by U). The user may use the user interface 160 to enter additional information including the model name of each of the components (e.g., disk drives) in response to prompts on the final screen. However, other configurations may be used by the executable instructions for identifying components 172 to provide prompts for the user to input the model name of each of the components (e.g., disk drives). For example, the prompts for the user to input the model name of each of the components (e.g., disk drives) may be displayed at the same time as when the prompts are displayed to input the type, number and alignment of the data disks). By receiving, from the user, the input of the model name of each of the components (e.g., disk drives), the model name of each of the components (e.g., disk drives) may be pre-populated.

Examples of systems described herein may include a logical/physical address association, such as the logical/physical address association 170 of FIG. 1. The logical/physical address association may be implemented using, for example, one or more memory devices. In some examples, the logical/physical address association 170 may be wholly and/or partially implemented using one of the computing nodes of a distributed computing system described herein. However, in some examples (such as shown in FIG. 1), the logical/physical address association 170 may be a different computing system from the virtualized system and may be in communication with a controller VM of the virtualized system (e.g., controller VM 108 of FIG. 1) using a wired or wireless connection (e.g., over a network). The logical/physical address association 170 may include a library of configuration files to use when the user is imaging new hardware during the automated process for qualifying the new platform for each of the computing nodes.

The information collected by using the executable instructions for identifying components 172 including details regarding the arrangement of the data disks, such as the type, number, alignment, and location of the data disks, may be stored in the logical/physical address association 170. The information collected by using the executable instructions for identifying components 172 and stored in the logical/physical address association 170 may be used during operation of the distributed computing system to transmit, to a hardware component to be controlled, a command specific for intended hardware component specific commands for the hardware component.

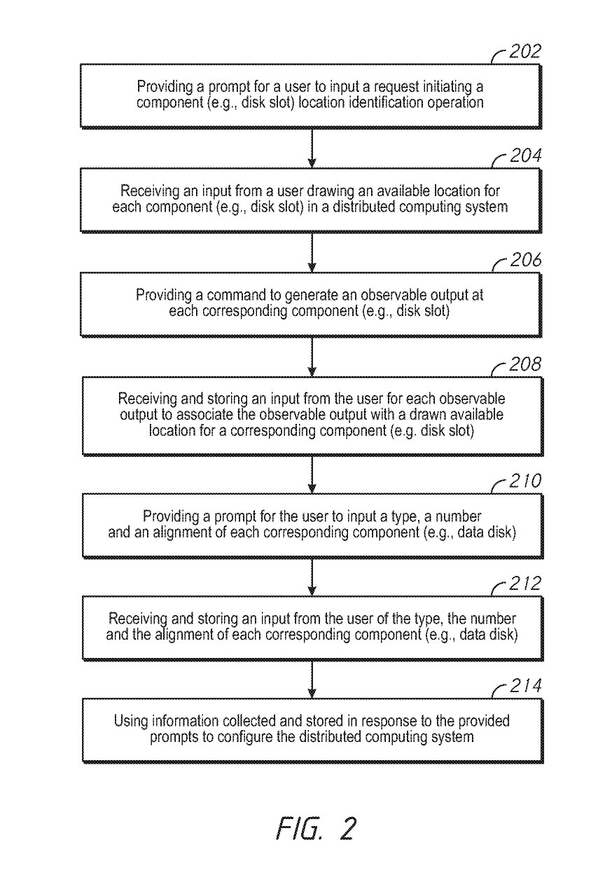

FIG. 2 is a flow diagram of an implementation of executable instructions for identifying components according to examples described herein. The flowchart may include displaying a variety of user prompts and/or other guidance to solicit input for qualifying the platform. The flowchart may include controlling the user interface, which may be implemented by the user interface 160 of FIG. 1, to provide cues to a user and guide the user through screens used to collect information which helps complete the picture of an arrangement of the components. For example, the flowchart may include a step 202 for providing a prompt for a user to input a request initiating a component (e.g., disk slot) location identification operation. Associations between logical and physical addresses of components information may be stored based on information provided by the user and collected by using an administration system. The providing of the request initiating the component (e.g., disk slot) location identification operation may include using the executable instructions to control the user interface to display a set of screens for the user to draw available locations of all components (e.g., disk slots) available. For example, the flowchart may include a step 204 for receiving an input from a user drawing an available location for each component (e.g., disk slot) in a distributed computing system. Information about the available locations for the components (e.g., disk slots) may also be obtained in some other way (e.g., pre-stored).

The flowchart may include a step 206 for providing a command to generate an observable output at each corresponding component (e.g., disk slot). The executable instructions for identifying components may be implemented as described above with respect to the executable instructions for identifying components 172 of FIG. 1. The observable output generated at each corresponding component (e.g., disk slot), one by one, may include, for example, a disk LED that is activated (e.g., blinked). A variety of configurations between the executable instructions for identifying components 172 and the computing nodes (e.g., computing node 102) may be used to activate (e.g., blink) the outputs (e.g., disk LEDs). For example, the executable instructions for identifying components 172 may transmit a signal via the computing node 102 to an output (e.g., disk LED) of a component (e.g., disk drive). Alternatively, the executable instructions for identifying components 172 may transmit a signal to flag the computing node 102 to transmit a signal enabling the output (e.g., disk LED) of the disk drive to activate (e.g., blink). A variety of configuration processes may be used by the executable instructions for identifying components 172 by generating outputs including activating (e.g., blinking) a single output (e.g., disk LED) or activating (e.g., blinking) a plurality of outputs (e.g., disk LEDs). The outputs (e.g., disk LEDs) are activated (e.g., blinked) so that the user may input information regarding an available location of one of the components (e.g., disk slots). This is a critical step because the slot to physical (i.e., slot-to-phy) mapping of the disks is generated, which helps workflows such as pointing out the faulty disk in case of disk failures. A variety of configuration methods may be used for the user to input the information regarding the available location of the corresponding component (e.g., disk slot) including the user clicking on a portion of the user interface to select a representative image of the corresponding component (e.g., disk slot) or drawing a symbol representing the available location of the corresponding component (e.g., disk slot).

The user interface may be controlled by the executable instructions for identifying components to display a plurality of screens to detect sensors. For example, the flowchart may include a step 208 for receiving and storing an input from the user for each observable output to associate the observable output with a drawn available location for a corresponding component (e.g. disk slot). In a case where locating sensors on the chassis makes sense, sensors on the chassis may be located by the user clicking on a portion of the user interface corresponding to each of the sensors in response to a prompt by the user interface.

Prompts may be provided on the user interface 160 for the user to input the type, number and alignment of each of the components (e.g., data disks) by using the executable instructions for identifying components 172. For example, the flowchart may include a step 210 for providing a prompt for the user to input a type, a number and an alignment of each corresponding component (e.g., data disk). The providing of the prompts for the user to input the type, the number and the alignment of each of the components (e.g., data disks) may include controlling, via the executable instructions for identifying components, the user interface to display a final screen for verifying all of the information obtained in the previous steps. The executable instructions for identifying components may control the user interface to display the final screen to provide a prompt requesting the user to enter the chassis form factor, which is generally a multiple of a unit of rack space (e.g., denoted by U). The user may use the user interface to enter additional information including the model name of each of the components (e.g., disk drives) in response to prompts on the final screen. However, other configurations may be used by the executable instructions for identifying components to provide prompts for the user to input the model name of each of the components (e.g., disk drives). For example, the prompts for the user to input the model name of each of the components (e.g., disk drives) may be displayed at the same time as when the prompts are displayed to input the type, number and alignment of the components (e.g., data disks). By receiving, from the user, the input of the model name of each of the components (e.g., disk drives), the model name of each of the components (e.g., disk drives) may be pre-populated.

The flowchart may include a step 212 for receiving and storing an input from the user of the type, the number and the alignment of each corresponding component (e.g., data disk). The flowchart may include a step 214 for using information collected and stored in response to the provided prompts to configure the distributed computing system.

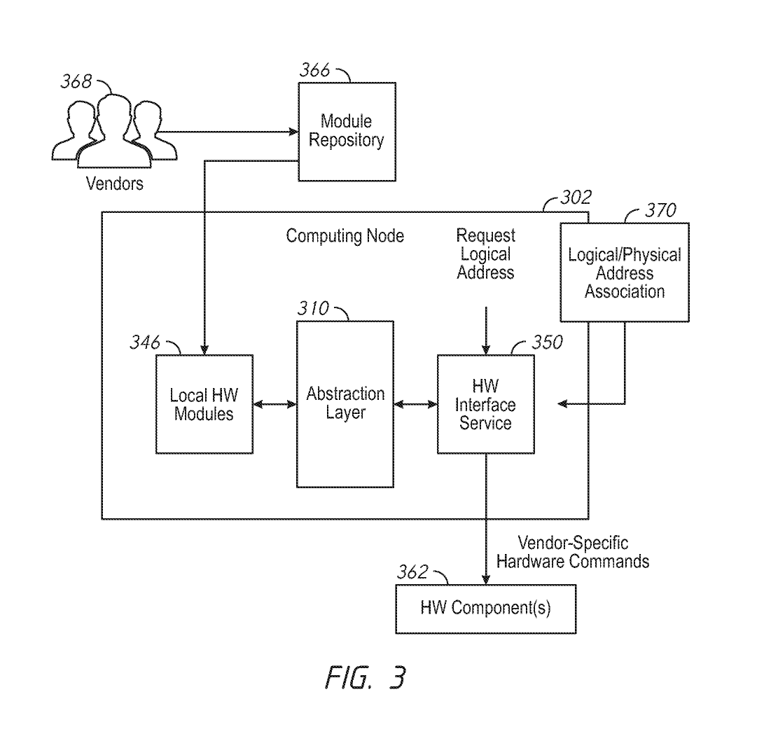

FIG. 3 is a schematic illustration of a computing node having a HW interface service arranged in accordance with examples described herein. FIG. 3 includes computing node 302 which may be used to implement and/or may be implemented as described above with respect to computing node 102 and/or 112 of FIG. 1 in some examples. FIG. 3 illustrates vendors 368, module repository 366, HW interface service 350, abstraction layer 310, local HW modules 346, HW component(s) 362, and a logical/physical address association 370. Module repository 366, HW interface service 350, local HW modules 346, HW component(s) 362, and logical/physical address association 370 may be analogous to module repository 166, HW interface service 150, HW modules 146, HW component(s) 162, and logical/physical address association 170 of FIG. 1 in some examples.

Vendors 368 (and/or others) may provide one or more hardware modules in module repository 366. At the time the computing node 302 is imaged and/or otherwise configured, local HW modules 346 may be provided at the computing node 302 from the module repository 366 (e.g., using a setup service described herein). The storage of the module repository 366 may be stored in a storage, which may be implemented as described above with respect to storage 140 of FIG. 1, or may be stored in a location other than virtualized storage.

During configuration, a user interface may provide prompts to request the user to enter the physical addresses of a plurality of HW components 362 (e.g., identification of a selected one of the plurality of HW components 362) to be stored in the logical/physical address association 370. The user interface may be implemented as described above with respect to user interface 160 of FIG. 1. The user interface may be displayed on a display device and may include a visual representation for a user to input available locations of a plurality of HW components 362 (e.g., physical addresses of the plurality of HW components 362) in accordance with their logical identifications. Information about the available locations for the HW components 362 may also be obtained in some other way (e.g., pre-stored).

After the available locations of the plurality of HW components 362 are input, the user interface may sequentially command each of the plurality of HW components 362, in accordance with their respective hardware identification, to provide an output. The user interface may prompt, via the display of the administration system (refer to FIG. 1), the user to provide an identification of a selected one of the plurality of HW components 362 responsive to the output. The user interface may receive the physical addresses of the HW components 362 from the user and provide the physical address to the HW interface service 350. The plurality of HW components 362 may include a plurality of storage disks, each including a respective LED. The output may include activation of the respective LED. The plurality of HW components 362 may include a plurality of sensors. The administration system may be further configured to discover the plurality of sensors.

The user interface may store the physical addresses and the logical addresses of the HW component 362 (e.g., logical hardware identifiers (IDs) for each of the HW components 362) in the logical/physical address association 370. In other words, the user interface may store, in the logical/physical address association 370, an association between the plurality of HW components 362 and a plurality of logical hardware IDs based on the identification. For example the logical/physical address associations 370 may be stored in local HW modules 346 in some examples and/or may be stored in storage, which may be implemented as described above with respect to storage 140 in FIG. 1.

During configuration, the user interface may display prompts for the user to input a type, number and alignment of the components (e.g., data disks) by using the executable instructions for identifying components 172. The user interface may display, during configuration, a final screen to provide a prompt requesting the user to enter the chassis form factor, which is generally a multiple of a unit of rack space (e.g., denoted by U). The final screen may be used for verifying all of the information obtained in the previous steps. The user may use the user interface to input additional information, the additional information including the model name of each of the HW components 362 in response to prompts on the final screen. However, other configurations may be used to provide prompts for the user to input the model name of each of the HW components 362. The prompts for the user to input the model name of each of the HW components 362 may be displayed at the same time as when the prompts are displayed to input the type, number and alignment of the components (e.g., data disks). By receiving, from the user, the input of the model name of each of the components (e.g., data disks), the model name of each of the components (e.g., data disks) may be pre-populated.

Information collected regarding the HW components 362 including details regarding the arrangement of the HW components 362, such as the type, number, alignment, and location of the HW components 362, may be stored in the logical/physical address association 370 (e.g., and/or stored in local memory described herein). The information collected by using the executable instructions for identifying HW components and stored in the logical/physical address association 370 may be used during operation of the distributed computing system to transmit, to a hardware component to be controlled, a command specific for intended hardware component specific commands for the hardware component. The HW components 362 may be implemented as described above with respect to the HW components 162 or the HW components 164 of FIG. 1. The type, vendor, version, and/or other identifying information regarding components of the computing node 302, including the operating system executed by the controller VM 302, and/or user VM, may be stored in the logical/physical address association 370.

During operation, a computing node running a requested controller VM (e.g., computing node 302 running controller VM) may receive a storage request from a hypervisor. The controller VM may be implemented as described above with respect to controller VM 108 or 118 of FIG. 1). The hypervisor may implemented as described above with respect to hypervisor 110 or 120 of FIG. 1). The computing node running a requested controller VM (e.g., computing node 302 running controller VM described herein) may also receive a control request from a hypervisor (e.g., hypervisor described herein). Responsive to the store request or control request, the computing node 302 may transmit, to the abstraction layer 310, generic hardware component commands which are processed and interpreted by the abstraction layer 310 and transmitted to the HW interface service 350.

The HW interface service 350 may interact with the local HW modules 346 by using the abstraction layer 310 to interpret the control request transmitted from the hypervisor via local HW modules 346. The HW interface service 350 may transform the generic hardware component commands into vendor-specific hardware commands. For example, the HW interface service 350 may receive, from the abstraction layer 310, the control request interpreted by the abstraction layer 310 and create vendor-specific hardware commands which may be provided to the HW components 362. The HW interface service 350 may provide the vendor-specific hardware commands to the HW components 362 by providing the logical address of the HW component 362 to the logical/physical address association 370 to receive the physical address of the HW component from the logical/physical address association 370. The vendor-specific hardware commands provided by the HW interface service 350 to the HW components 362 may be used to store data in HW components 362, or to control hardware, such as obtain sensor readings, and/or turn on and/or off lights (e.g., blink lights).

HW interface services described herein may provide for a certain set of programming objects (e.g., programming code) specifying generic functionality to be selectively overridden or specialized (e.g., translated) by specialized programming objects (e.g., programming code) providing specific functionality. For example, the local HW modules 346 may be implemented using one or more HW component-specific (e.g., vendor-specific) software code (e.g., plug-ins). The abstraction layer 310 may be implemented using an API interface to the local HW modules 346 which facilitates translation between a generic command and the HW component-specific (e.g., vendor specific) software in the local HW modules 346.

A HW component-agnostic (e.g., vendor-agnostic) application programming interface (API) may be provided between VMs described herein and hardware modules. The hardware modules may include HW component-specific (e.g., vendor-specific) programming code and/or commands. VMs described herein (e.g., user VMs and/or controller VMs) may provide and/or receive requests to control hardware which include commands generic to one or more hardware components. The abstraction layer 310 may represent the transformation of the generic commands to the HW component-specific commands.

The programming code to perform the transformation may vary in implementation and/or location. In some examples, at least a portion of the abstraction layer 310 may be implemented in an API wrapper based on a RESTful API at instances of the local HW modules 346. For example, the local HW modules 346 themselves may incorporate the abstraction layer 310. Other API layer implementations such as function calls, and/or remote procedure calls and methods are possible. The generic hardware component commands transformed by the abstraction layer 310 may be used to control hardware, such as obtain sensor readings, and/or turn on and/or off lights (e.g., blink lights).

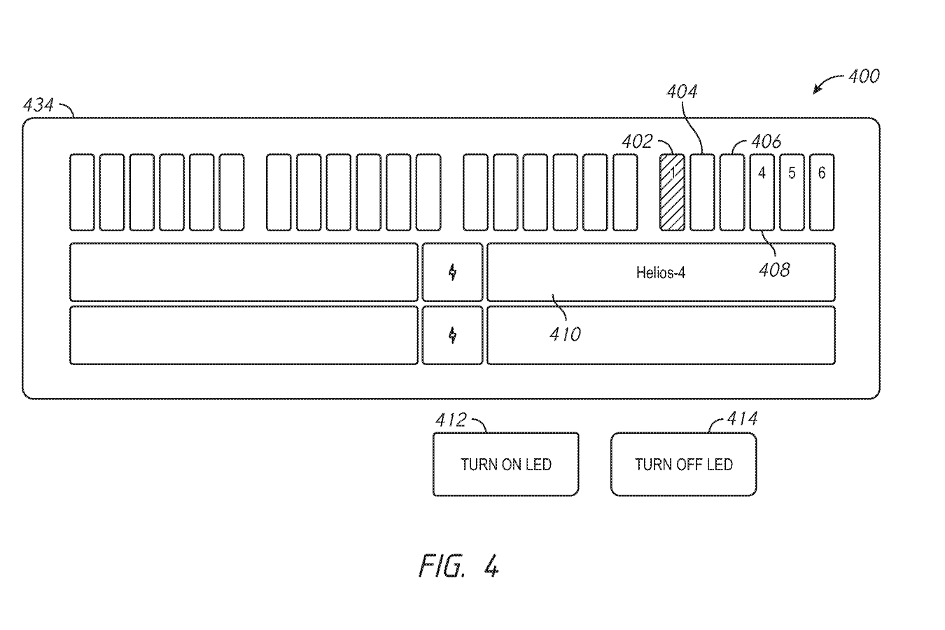

FIG. 4 is a schematic illustration of a user interface display arranged in accordance with examples described herein. In the example of FIG. 4, an enclosure 434 may include a display 400 configured to display a graphical representation of a computing system, for example, the computing system of FIG. 1. The display 400 may be presented on a user interface of an administration system described herein, such as the user interface 160 of FIG. 1. The graphical representation may include a first slot 402, a second slot 404, a third slot 406, a fourth slot 408, and a computing node 410.

The enclosure 434 includes the first slot 402, second slot 404, third slot 406, and fourth slot 408. Each of the first slot 402, second slot 404, third slot 406, and fourth slot 408 may include a storage device (e.g., a hard drive). For example, disks included in the storage 140 of FIG. 1 may be arranged in some or all of the slots shown in FIG. 4. One or more computing nodes may also be shown in the graphical representation, such as the computing node 410, referred to as “helios-4” in FIG. 4. The computing node 410 may be used to implement and/or may be implemented by the computing node 102 and/or 112 of FIG. 1 in some examples. In the example of FIG. 4, each of the storage devices which may correspond to the slots shown may include at least one LED. The LEDs may be hardware components which may be controlled in accordance with examples described herein.

In the example of FIG. 4, a turn on LED 412 and a turn off LED 414 may be buttons or other interface elements used to selectively turn on and turn off LEDs for the storage devices in the slots. In some examples, a storage device may be in need of attention (e.g., there may be an indication, from an automated system and/or from an operator), that a particular storage device may need to be checked, removed, upgraded, disposed of, or otherwise identified. It may be difficult in a data center containing a large volume of computing components to identify the particular storage device in need of attention. Accordingly, in examples described herein, it may be desirable to turn on and/or blink a light (e.g., an LED) on the particular storage device in need of attention.

To control the light on a particular storage device, referring to FIG. 4, a user (e.g., a system administrator) may view the graphical representation of the computing system. The user may select the storage device in need of attention (e.g., the storage device at slot 402). The storage device may be selected by, e.g., clicking, highlighting, typing an identification of the storage device, etc. In some examples, the storage device in need of attention may be selected by an automated process (e.g., software). The user may then cause a light to be turned on and/or off by selecting the buttons turn on LED 412 and/or turn off LED 414. In some examples, a button “blink LED” may be provided. These user inputs may provide a request to control the hardware—e.g., the request to control hardware provided to the HW interface service 350 in FIG. 3 and/or to HW interface service 150 and/or 156 of FIG. 1. The generic command to turn on, turn off, and/or blink an LED may be provided together with an indication of a location of the HW component. As described herein, a HW interface service may provide the specific command to turn on, turn off, and/or blink the LED to the actual LED hardware present at the indicated location.

By indicating the location of the particular hardware component, delay may be reduced and/or avoided between the time at which a hardware problem occurs and the time at which a technician may locate the problematic hardware. As a result, administrators can become aware of the hardware problems in a timely manner, and take corrective action to replace or repair faulty equipment to increase performance efficiency and decrease operation costs.

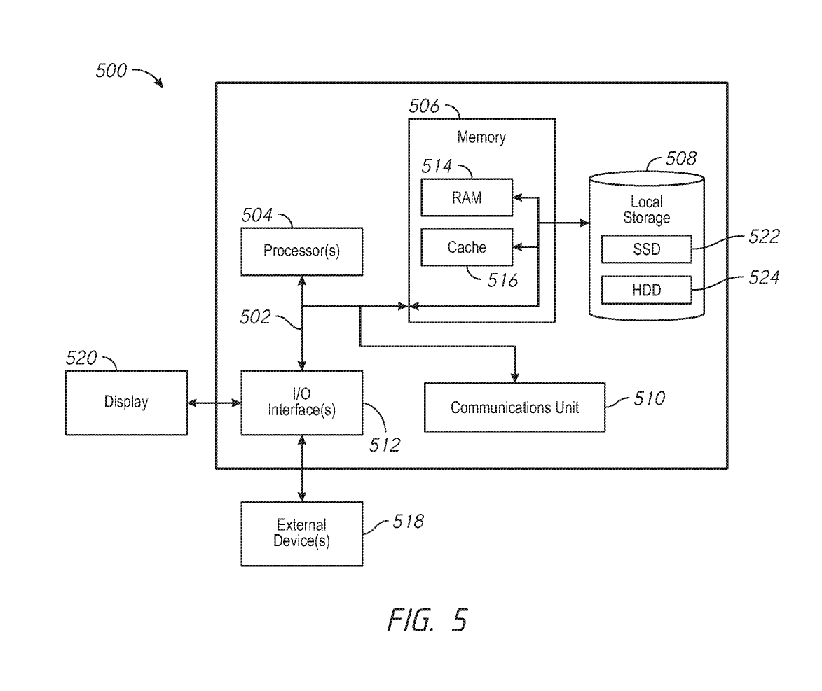

FIG. 5 is a block diagram of components of a computing node according to an embodiment. It should be appreciated that FIG. 5 provides only an illustration of one implementation and does not imply any limitations with regard to the environments in which different embodiments may be implemented. Many modifications to the depicted environment may be made. For example, a computing node 500 may be implemented as the computing node 102 and/or computing node 112 (refer to FIG. 1).

The computing node 500 includes a communications fabric 502, which provides communications between one or more processor(s) 504, memory 506, local storage 508, communications unit 510. I/O interface(s) 512. The communications fabric 502 can be implemented with any architecture designed for passing data and/or control information between processors (such as microprocessors, communications and network processors, etc.), system memory, peripheral devices, and any other hardware components within a system. For example, the communications fabric 502 can be implemented with one or more buses.

The memory 506 and the local storage 508 are computer-readable storage media. In this embodiment, the memory 506 includes random access memory RAM 514 and cache 516. In general, the memory 506 can include any suitable volatile or non-volatile computer-readable storage media. The local storage 508 may be implemented as described above with respect to local storage 124 and/or local storage 130. In this embodiment, the local storage 508 includes an SSD 522 and an HDD 524, which may be implemented as described above with respect to SSD 126, SSD 132 and HDD 128, HDD 134 respectively (refer to FIG. 1).

Various computer instructions, programs, files, images, etc. may be stored in local storage 508 for execution by one or more of the respective processor(s) 504 via one or more memories of memory 506. In some examples, local storage 508 includes a magnetic HDD 524. Alternatively, or in addition to a magnetic hard disk drive, local storage 508 can include the SSD 522, a semiconductor storage device, a read-only memory (ROM), an erasable programmable read-only memory (EPROM), a flash memory, or any other computer-readable storage media that is capable of storing program instructions or digital information.

The media used by local storage 508 may also be removable. For example, a removable hard drive may be used for local storage 508. Other examples include optical and magnetic disks, thumb drives, and smart cards that are inserted into a drive for transfer onto another computer-readable storage medium that is also part of local storage 508.

Communications unit 510, in these examples, provides for communications with other data processing systems or devices. In these examples, communications unit 510 includes one or more network interface cards. Communications unit 510 may provide communications through the use of either or both physical and wireless communications links.

I/O interface(s) 512 allows for input and output of data with other devices that may be connected to computing node 500. For example, I/O interface(s) 512 may provide a connection to external device(s) 518 such as a keyboard, a keypad, a touch screen, and/or some other suitable input device. External device(s) 518 can also include portable computer-readable storage media such as, for example, thumb drives, portable optical or magnetic disks, and memory cards. Software and data used to practice embodiments of the present invention can be stored on such portable computer-readable storage media and can be loaded onto local storage 508 via I/O interface(s) 512. I/O interface(s) 512 also connect to a display 520.

Display 520 provides a mechanism to display data to a user and may be, for example, a computer monitor.

From the foregoing it will be appreciated that, although specific embodiments have been described herein for purposes of illustration, various modifications may be made while remaining with the scope of the claimed technology.

What is claimed is:

1. A system comprising:
an administration system comprising a user interface (UI);
a storage pool comprising a plurality of storage devices; and
a plurality of computing nodes in communication with the administration system, the plurality of computing nodes each comprising at least one of the plurality of hardware components, and each further comprising a hypervisor, a plurality of user virtual machines, and a controller virtual machine, the controller virtual machine configured to virtualize the storage pool for the plurality of user virtual machines;
wherein the administration system is configured to:
display a visual representation of the plurality of hardware components in accordance with their logical identification;
sequentially command each of the plurality of hardware components, in accordance with their respective hardware identification, to provide an output;
prompt, via a display device of the administration system UI, a user to provide an identification of a selected one of the plurality of hardware components responsive to the output; and
store an association between the plurality of hardware components and a plurality of logical hardware identifiers (IDs) based on the identification.

2. The system of claim 1, wherein, to display the visual representation of the plurality of hardware components in accordance with their logical identification, the administration system is further configured to display a message requesting an input of a chassis form factor as a multiple of a unit of rack space of a chassis.

3. The system of claim 1, wherein, to prompt the user to provide the identification, the administration system is further configured to display multiple disk slots available.

4. The system of claim 3, wherein the identification is made by the user selecting at least one of multiple disk slots available corresponding to each respective storage device providing an output.

5. The system of claim 4, wherein the output comprises a visual output.

6. The system of claim 5, wherein the plurality of hardware components comprise a plurality of storage disks, each including a respective light emitting diode (LED), and wherein the output comprises activation of the respective LED.

7. The system of claim 6, wherein said sequentially commanding each of the plurality of hardware components to provide the output comprises causing an initial one of the plurality of components to blink its LED until the identification is received by the administration system, then causing another one of the plurality of components to blink its LED.

8. The system of claim 1, wherein the plurality of hardware components comprise a plurality of sensors.

9. The system of claim 8, wherein the administration system is further configured to discover the plurality of sensors.

10. A method comprising:
displaying, via an administration system, a visual representation of a plurality of hardware components in accordance with their logical identification, wherein the administration system comprises a user interface (UI), wherein a plurality of computing nodes in communication with the administration system each comprise at least one of the plurality of hardware components, and each further comprises a hypervisor, a plurality of user virtual machines, and a controller virtual machine, and wherein the controller virtual machine is configured to virtualize a storage pool for the plurality of user virtual machines;
sequentially commanding, via the administration system, each of the plurality of hardware components, in accordance with their respective hardware identification, to provide an output;
prompting, via the administration system, a user to provide an identification of a selected one of the plurality of hardware components responsive to the output; and
storing, via the administration system, an association between the plurality of hardware components and a plurality of logical hardware identifiers (IDs) based on the identification.

11. The method of claim 10, wherein the displaying the visual representation of the plurality of hardware components in accordance with their logical identification further comprises, displaying, by the administration system, a message requesting an input of a chassis form factor as a multiple of a unit of rack space of a chassis.

12. The method of claim 10, wherein the prompting the user to provide the identification further comprises displaying multiple disk slots available.

13. The method of claim 10, wherein the identification is made by the user selecting at least one of multiple disk slots available corresponding to each respective storage device providing an output.

14. The method of claim 10, wherein the output comprises a visual output.

15. The method of claim 14, wherein the plurality of hardware components comprise a plurality of storage disks, each including a respective light emitting diode (LED), and wherein the output comprises activation of the respective LED.

16. The method of claim 10, wherein said sequentially commanding each of the plurality of hardware components to provide the output comprises causing an initial one of the plurality of components to blink its LED until the identification is received by the administration system, then causing another one of the plurality of components to blink its LED.

17. The method of claim 10, wherein the plurality of hardware components comprise a plurality of sensors.

18. The method of claim 17, wherein the administration system is further configured to discover the plurality of sensors.

19. A non-transitory computer readable medium encoded with executable instructions, which, when executed, cause an administration system to:
display a visual representation of a plurality of hardware components in accordance with their logical identification, wherein the administration system comprises a user interface (UI), wherein a plurality of computing nodes in communication with the administration system each comprise at least one of the plurality of hardware components, and each further comprises a hypervisor, a plurality of user virtual machines, and a controller virtual machine, and wherein the controller virtual machine is configured to virtualize a storage pool for the plurality of user virtual machines;
sequentially command each of the plurality of hardware components, in accordance with their respective hardware identification, to provide an output;
prompt a user to provide an identification of a selected one of the plurality of hardware components responsive to the output; and
store an association between the plurality of hardware components and a plurality of logical hardware identifiers (IDs) based on the identification.

20. The non-transitory computer readable medium of claim 19, wherein the plurality of hardware components comprise a plurality of storage disks, each including a respective light emitting diode (LED), and wherein the output comprises activation of the respective LED, and wherein said sequentially commanding each of the plurality of hardware components to provide the output comprises causing an initial one of the plurality of components to blink its LED until the identification is received by the administration system, then causing another one of the plurality of components to blink its LED.

21. The non-transitory computer readable medium of claim 19, wherein the plurality of hardware components comprise a plurality of sensors, and wherein the administration system is further configured to discover the plurality of sensors.

22. The non-transitory computer readable medium of claim 19, wherein, to prompt the user to provide the identification, the executable instructions, when executed, further cause the administration system to display multiple disk slots available, and wherein the identification is made by the user selecting at least one of multiple disk slots available corresponding to each respective storage device providing the output.

23. The non-transitory computer readable medium of claim 19, wherein, to display the visual representation of the plurality of hardware components in accordance with their logical identification, the executable instructions, when executed, further cause the administration system to display a message requesting an input of a chassis form factor as a multiple of a unit of rack space of a chassis.
